(19) United States
(12) Patent Application Publication
(10) Pub. No.: US 2021/0299498 A1
(43) Pub. Date: Sep. 30, 2021

(54) A Fire Fighting System for Extinguishing a Fire in a Room of a Building, A Method Thereof and Use of an Array Sensor Therein

(71) Applicant: Minimax Viking Research & Development GmbH, Bad Oldesloe (DE)

(72) Inventors: Klaus HOFMANN, Bad Oldesloe (DE); Joachim BÖKE, Bad Oldesloe (DE)

(21) Appl. No.: 17/261,859

(22) PCT Filed: Jul. 26, 2019
(86) PCT No.: PCT/EP2019/070207

§ 371 Date: Jan. 20, 2021

(30) Foreign Application Priority Data
Jul. 27, 2018 (DE) 10 2018 118 300.3

(51) Int. Cl. A62C 37/40; G01J 5/00; G08B 17/12

(52) U.S. Cl. CPC A62C 37/40; G08B 17/12; G01J 5/0066

(57) ABSTRACT

The invention relates to a fire fighting System (1) for extinguishing a fire in a room (101) of a building (100), comprising at least one stationary fire locator device (7) configured to locate a fire (F), a plurality of stationary fire fighting devices (3a, b), each associated with and configured to distribute fire extinguishing fluid within a respective zone (11a,b) of the room (101), and a Controller (9) that is in Signal communication with the at least one locator device (7) and with the extinguishing devices (3a, b). In a preferred embodiment the invention is configured to activate at least one of the extinguishing devices (3a, b) in reaction to identifying the fire (F); wherein the at least one locator device (7) comprises an array sensor (19), said array sensor (19) having a plurality of pixels that are sensitive to electromagnetic radiation, and arranged in a grid (17) of pixels, wherein each pixel is associated with a specific portion of the room, the Controller (9) is configured to locate the zone of the room (101) having the fire (F) by identifying hot spots formed by those pixels which sense electromagnetic radiation exceeding a predetermined threshold level (T₁), and to activate the at least one fire fighting device (3a, b) associated with the located zone.

The invention relates to a fire fighting system for extinguishing a fire in a room of a building. The invention further relates to a method of extinguishing a fire in said room, and to a use of an array sensor in such a system.

Fire fighting systems of the aforementioned type are generally known in the art. The known systems typically employ a number of fire detection devices to monitor the room for the presence of a fire. Once the presence of said fire has been determined, a controller that is in signal communication with the detection devices typically activates fluid distribution in the room by activating a number of, i.e. one or more, fire fighting devices. The term “fire fighting” is understood to encompass at least one of control, suppression and extinguishing to a fire.

In practice, damage to the room and the building is not only caused by a spreading fire, but also by the extinguishing fluid itself. Thus, it is generally desirable to minimize the amount of extinguishing fluid necessary for extinguishing a fire in a room of a building. The prior art suggests the use of optical detection systems, for example detection systems having one or more infrared cameras to monitor the room and aid in identifying the presence of a fire.

Also, these systems are used to monitor the development of a fire over time in order to assess the success or failure of an extinguishing attempt such that fluid distribution may be stopped in a timely manner.

WO 2016/032546 A1 suggests to assemble a plurality of detector devices in close proximity to one another, and to activate one or more fire sprinklers based upon a calculation of a location of the fire or based upon the signals supplied by the respective detector devices. The complexity of calculating a fire location based upon a plurality of detector devices is considered to be a disadvantage, however.

U.S. Pat. No. 7,286,704 B2 discusses the use of an imaging device detect a fire from a recorded image sequence. Specifically, an infrared camera such as a heat imaging camera or thermopile array, is used to record a sequence of images. Image processing software is then used to calculate the development of a heat map over time in order to identify the to presence of a fire in a room. U.S. Pat. No. 7,286,704, however, falls short in that it does not provide for a precise localization of the fire within a room. US 2008/0272921 A1 similarly discloses a fire detection system wherein an infrared detector array is used to recode a sequence of images of time, and calculates the development of a fire based upon image comparison.

It was an object of the invention to provide a system for, and method of, extinguishing a fire in a room of a building which allows for efficient fire fighting action while still being economically affordable. In particular, it was a further object of the invention to provide such a system and method which allow for a minimized use for extinguishing fluid without sacrificing extinguishing performance.

The invention attains this object in a first aspect by suggesting a system for extinguishing a fire in a room of a building according to claim 1. The system comprises:
at least one stationary fire locator device configured to locate a fire,
a plurality of stationary fire fighting devices, each associated with and configured to distribute fire extinguishing fluid within a respective zone of the room, and
a controller that is in signal communication with the at least one locator device and with the extinguishing devices, and is configured to
activate at least one of the fire fighting devices in reaction to identifying the fire; wherein
the at least one locator device comprises an array sensor, said array sensor having a plurality of pixels that are sensitive to electromagnetic radiation, and arranged in a grid of pixels, wherein each pixel is associated with a specific portion of the room,
the controller is configured to
locate the zone of the room having the fire by identifying hot spots formed by those pixels which sense electromagnetic radiation exceeding a predetermined threshold level, and to
activate the at least one fire fighting device associated with the located zone.

The invention is based upon the realization that it is not necessary for reliably and efficiently extinguishing a fire to determine the exact and precise spot of the fire source. Instead, the invention is based upon the understanding that it is sufficient to determine the zone in which the fire exists, and to activate the respective fire fighting device which is responsible for covering the identified zone. This principle enables a use of a comparatively low-resolution array sensor that is very cost efficient, yet at the same time works very reliably. After installing and orienting the array sensor, and ascertaining that each pixel covers a specific portion of the room, the controller is able to immediately associate the correct number of to extinguishing devices to a detected hot spot within the grid of pixels monitored. Since every pixel of the array sensor corresponds to one specific portion of the room, which is known, no additional calculation steps are necessary, which makes the system very easy to program and fast to operate, while at the same time requiring minimal financial investments. And additional benefit of relying on an array sensor having a plurality of pixel arranged in a grid, wherein each pixels is associated with a specific portion of the room, it becomes also very easy to scale the system to protect very large rooms, or rooms with very complex geometries.

For the invention, the term “stationary” is understood to mean that the respective stationary object is fixedly arranged without movement.

In preferred embodiments, the fire fighting device comprises a controllable sprinkler or an open extinguishing nozzle. The controllable sprinkler is preferably designed as an electrically activatable sprinkler or as a nozzle cooperating with or comprising a sealing device which is configured to open to discharge fire extinguishing fluid in response to receiving an electrical signal. The open extinguishing nozzle is preferably designed as one of: full cone spray nozzles, open side wall sprinkler type nozzles, or open nozzles with a flat spray pattern.

In a preferred embodiment, the controller is configured to allocate specific threshold values to each pixel. Herewith, it becomes possible to predefine locations of stationary hotspots that are indicative of fire-unrelated heat sources. By doing so, the sensitivity of each pixel can be customized. In a given room, there will normally be heat sources such as heaters, stoves, cooking equipment etc. When in operation, these heat sources will generate a hotspot on the array sensor (or be detected by a heat imaging device). The invention accounts for these stationary hotspots in that it becomes possible to assign a specific threshold value to each pixel of the array sensor. Specifically, some portions of the room which comprise a stationary hotspot may be assigned with a higher specific threshold value than other portions of the room in which no stationary hotspots are to be expected. Additionally or alternatively, specific threshold values may be assigned to account for geometric properties of the room such as the distance of the portion covered by a specific pixel to a heat source etc. In operation, the array sensor will then still recognize temperature changes in the area where the stationary hotspots are located, but it will not trigger a false positive alarm unless the stationary hotspot grows warmer than normal. It is also possible to designate a threshold value that will permanently prevent causing an alarm signal for the respective pixel.

In preferred embodiments, the pixels of the array sensor are sensitive to at least one of: ultraviolet light, visible light, or infrared light. Particularly preferred, the array sensor is a thermopile array sensor, each pixel comprising a thermopile element. Thermopile elements have the advantage that they provide for a high temperature resolution, are thus highly capable of detecting hot spots due to fires, and are available at low cost.

In a further preferred embodiment, the fire fighting system further comprises at least one fire detector device in addition to the fire locator device, the fire detector device preferably being selected from the list consisting of: smoke detector, in particular optical beam smoke detector or aspiration smoke detector; flame detector, in particular IR flame detector, UV flame detector or combined IR/UV flame detector; heat detector; gas detector; or multi-sensor-detector.

Preferably, the at least one fire detector device is configured to generate a signal indicative of the presence of the fire in the room, and the controller is configured to activate the at least one fire fighting device only when the at least one fire detector device has indicated the presence of the fire and the controller has located the zone having the fire based on the signals received from the fire locator device. By implementing at least one fire detector device in addition to the fire locator, it becomes possible to provide a double interlock system in which the fluid extinguishing devices are only activated when both a detection of a fire and the location of the zone in which the fire persists have been achieved.

In further preferred embodiments, the fire fighting system comprises at least one of: a plurality of fire locator devices, or a plurality of fire detector devices. Particularly preferred, the fire fighting system comprises at least two ire detector devices which provide for a double interlock detection of the presence of the fire in the room. Such an embodiment meets all regulatory requirements and has the enhanced benefit of additionally comprising a fire locator device which helps to quickly identify the zone in which the fire exists and which allows for a zone-specific fluid distribution through the respective activation of at least one fire fighting device.

Preferably, the controller comprises a microprocessor that is configured to determine the temperature in each portion of the room associated with a respective one of the pixels and generate a signal representative of said temperatures, preferably for each pixel. The controller is in a first preferred alternative integrated into the fire locator device. In a second preferred alternative, the controller is a separate unit and in signal communication with the fire locator device.

Further preferably, each of the fire fighting devices has a controlled trigger that is configured to activate a flow of extinguishing fluid from the fire fighting device upon receipt of an activation signal, and the controller is configured to generate said activation signal as a function of determining and locating the fire.

In a further aspect of the invention which is at the same time a preferred embodiment of the first aspect described herein above and a separate aspect in its own, the fire fighting system comprises a plurality of fluid extinguishing devices that are positioned and arranged in the room so as to respectively cover a zone of a predetermined size, a controller being configured to locate the zone containing the fire, and

a) if only one fire fighting device is positioned to cover the zone having the fire, to activate only that respective extinguishing device, or

b) if several fire fighting devices are positioned to cover the zone having the fire, to activate no more than two fire fighting devices covering the zone having the fire.

By programming the controller to limit the fluid distribution to no more than two fire fighting devices, the hydraulic demand of the system may be limited to the sum of hydraulic demands of the two fire fighting devices having the greatest hydraulic demands within in room. Also, this allows a leaner dimensioning of the fire fighting system as a whole, and leads to significantly reduced damage caused by fire extinguishing fluid in case of a fire.

In particularly preferred embodiments, the fire fighting system as described herein above with respect to the first aspect in combination with the second aspect is reactive enough such that most fires will successfully be fought by activating only one fluid extinguishing device. In particularly critical cases, a second fluid extinguishing device will be activated by the controller. According to the invention, it is however not necessary to activate more than two extinguishing devices, inter alia since the control algorithm is sufficiently quick in locating the inflicted zone on the first place.

In a further preferred embodiment, the room has a wall, a ceiling and a floor, and the at least one fire locator device is mounted to the wall or ceiling of the room and has a defined field of view directed toward the floor of the room, each of the pixels being associated with a segment of said field of view, such that each pixel covers the floor part of its associated specific portion of the room.

In a further preferred embodiment, the fire fighting system is a deluge system, and the fire fighting devices respectively comprise an open extinguishing nozzle, in particular one of: full cone spray nozzles, open side wall sprinkler type nozzles, or open nozzles with a flat spray pattern.

In a further preferred embodiment, the fire fighting system is a water-based extinguishing system, and the fire fighting devices respectively comprise a controllable sprinkler, particularly activated by the controlled trigger.

In preferred embodiments, the water-based extinguishing system uses one or more water-based extinguishing agents for fire fighting. Foaming agent concentrates, wetting agents, gel formers, retardants or salts may preferably be added to the water as extinguishing agent additive.

In preferred embodiments, the water-based extinguishing system is a water mist system or a foam extinguishing system.

The controllable sprinkler is preferably designed as an electrically activatable sprinkler or preferably as a nozzle with a sealing device which opens to discharge a water based extinguishing fluid for fire fighting getting an electrical signal.

In further preferred embodiments of the above-mentioned aspects, controllable fire fighting devices can preferably be arranged and oriented to have a more suitably adapted sprinkler pattern than classical sprinkler nozzles. This can further reduce the impact of excess fire extinguishing fluid to zones or portions of the room, which are not affected by the fire.

In a preferred embodiment, the plurality of fire fighting devices is arranged and oriented such that any square meter of floor surface in the fire fighting area is provided with at least 0.4 (l/m²)/min (at least 0.01 US gallon per minute (gpm) per square feet (sqf), i.e. 0.01 gpm/sqf) of fire extinguishing fluid. Expressed differently, this value corresponds to 0.4 liters impinging per minute per square meter, that is a water column of at least 0.4 mm height impinges per minute. Preferably, the amount of fire extinguishing fluid per square meter of floor surface is at least 0.8 (l/m²)/min (at least 0.02 gpm/sqf). Thereby, a reliable and efficient fire fighting can be performed while requiring an amount of fire extinguishing fluid which does not exceed and is even less than the amount indicated in UL 1626.

In a preferred embodiment, the plurality of fire fighting devices is further arranged and oriented such that a wall surface of the fire fighting area is wetted within at least 30 cm from to the floor of the room at the respective location of the wall surface. Thus, areas of the wall surface which are prone to significant heat impact due to, for instance, a fire are adequately wetted in order to assist the fire fighting process.

In a preferred embodiment the plurality of controllable fire fighting devices is designed to collectively cover all zones of at least the part of the room such that: any square meter of floor surface can be provided with at least 0.4 (l/m²)/min of fire extinguishing fluid. Preferentially, additionally any wall surface can be wetted within at least 30 cm from the floor of the room of the room at the respective location of the wall surface. Thereby, conformity of the system with fire fighting performance standards, in particular the relevant norm UL 1626 for residential sprinklers, can be obtained.

In a preferred embodiment each of the plurality of fire fighting devices is operable to provide one particular zone of the room with fire extinguishing fluid. The discharge pattern of each of the respective fire fighting devices is thus preferentially matched with the respectively corresponding zone. For instance, a suitable deflection means for deflecting the fire extinguishing fluid into the desired shape can be provided, while also other suitable solutions, such as specifically adapted fire fighting devices, are contemplated.

Thus, a one-to-one correspondence between nozzles and zones can be established. Advantageously, since the discharge pattern of the nozzles and the zone respectively corresponding thereto is known, a more efficient fire fighting can be achieved. For instance, by selectively activating or deactivating one or more of the nozzles, fire extinguishing fluid can be provided precisely to the zone or the zones corresponding to the activated/deactivated nozzles.

In a preferred embodiment the number of the plurality of fire fighting devices is equal to or lower than the number of the plurality of zones.

In case the number of nozzles is equal to the number of zones, a one-to-one correspondence between nozzles and zones as described above, can be determined. Reducing the number of nozzles to the needed amount assists in keeping the costs of the system according to the disclosure to a minimum. In case further the number of nozzles is reduced below the number of zones allows to more accurately determine the zones due to the higher resolution, while not increasing the costs due to a provision of more nozzles. In this embodiment, preferably each of the nozzles which are assigned more than one zone are steerable so as to discharge fire extinguishing fluid to one of the plurality of zones, to which they are respectively assigned. Even more preferably, the plurality of zones, to which a single nozzle is assigned in this embodiment, are not adjacent zones, but have a different zone assigned to a different nozzle line in-between. Thus, a situation can be avoided, in which both zones, which are adjacent to each other, would be part of the fire fighting area and would require the same controllable nozzle to be activated. Expressed differently, it can be ascertained that two adjacent zones, forming an fire fighting area, can always be activated by activating two controllable nozzles.

In a preferred embodiment a number of sensor elements of the array sensor is higher than a number of the plurality of zones, in particular the number of sensor elements is higher than the number of the plurality of zones by a factor of at least twelve, preferably of at least 27.

The factor of approximately twelve can for instance correspond to an array of sensor elements of 8×8 pixels, wherein the number of zones can then correspond to approximately five. Other examples comprise the use of three adjacently arranged arrays of 8×8 pixels each, while the number of zones exemplarily also corresponds to five or, in case of a larger room, to seven, of course without being limited. While the array sensor in this embodiment still has a much lower resolution then, for instance, a CCD camera or high resolution IR-camera and the like, it allows at a significantly lower cost to keep the risk for falls alarms due to more functioning of one or more of the individual sensor elements to a minimum. More specifically, since each zone is imaged by approximately 12 or at least 27 sensor elements, respectively, a very high statistical reliability can be achieved.

In a preferred embodiment the thermopile array comprises an array of eight times eight thermopile elements, wherein the number of the plurality of zones is less than the number of thermopile elements, wherein the number of the plurality of zones is in particular four to eight.

Of course, also higher or lower numbers of thermopile elements and/or zones are contemplated. Even further, it is contemplated to provide two or more thermopile arrays in one single room, wherein the two or more thermopile arrays can operate cooperatively or individually.

In a preferred embodiment the array sensor comprises at least three thermopile arrays arranged adjacently to each other, each comprising an array of eight times eight thermopile elements. Thus, a larger angle of view, for instance imaging a larger room, can be achieved.

In a preferred embodiment the controller is configured to associate each of the sensor elements of the array sensor to at least one of the zones so that at least two zones overlap. Since at least two zones overlap, a risk of insufficient coverage, particularly at the edges between two zones, can be reduced. Further, inaccuracies related to the definition of the zones have less impact.

In a preferred embodiment at least two adjacent zones out of the plurality of zones partially overlap at their edges, respectively.

Preferentially, in case adjacent zones overlap at their edges, a fire being determined in the overlapping portion of the adjacent zones can result in both of the adjacent zones being designated as the fire fighting area. It can thus be avoided that a fire being present at or near by an edge be insufficiently extinguished by activating both of the adjacent zones.

Further, even in case one of the controllable nozzles does not have a completely uniform discharge pattern of fire extinguishing fluid, e.g. a fluid flow is less near the edge of the zone covered by the respective nozzle, as a sufficient fluid flow of fire extinguishing fluid even for fires occurring at or near an edge of the respective zones can be guaranteed.

In a preferred embodiment at least one zone of the plurality of zones entirely overlaps one or more of the other zones of the plurality of zones. The zone entirely overlapping one or more of the other zones can be regarded a redundant zone, which is advantageous to activate in case the fire is detected far away from the centers of those zones, which are overlapped by the overlapping zone. It is thus not necessary to provide fire extinguishing fluid to areas far away from the detected fire by adding the overlapping zone to the fire fighting area. Accordingly, a risk of damaged to be access fire extinguishing fluid can be reduced.

In a preferred embodiment the room floor is distributed among four adjacent zones of the plurality of zones. A fifth zone of the plurality of zones is located in a central area of the room, overlapping a portion of each of the first to fourth zone of the plurality of zones. In a further preferred embodiment, also at least part of the wall surface is additionally distributed among the zones.

In a preferred embodiment a surface area of each of the plurality of zones is approximately equal. Thus, assuming that a fluid flow through each of the controllable fire fighting devices covering the fire fighting area is approximately equal, also the fluid flow to each portion of the respective zones is approximately equal. Thus, a homogeneous fluid supply to each portion of the room can be assured.

Preferentially, the surface area comprises a floor and a wall surface area. In some embodiments, the floor area can be given a higher weight, i.e. the calculation of the total area to be provided with fire extinguishing fluid of each zones can be biased towards the floor area. Thus, for example, a need for more fluid flow to the floor surface as compared to the wall surface per surface area can be implemented.

The invention has herein above been described according to a first and second aspect relating to the fire fighting system itself. In a further aspect, the invention also solves the object by suggesting a method of extinguishing a fire in a room of a building, comprising the steps of:
locating a zone of the room having a fire with at least one stationary fire locator device by
sensing electromagnetic radiation with a grid of pixels of an array sensor, wherein each pixel is associated with a predetermined specific portion of the room, and
identifying hot spots in the room by determining those pixels which sense electromagnetic radiation exceeding a predetermined threshold level; and
distributing an extinguishing fluid from at least one of a plurality of stationary fire fighting devices to the located zone, preferably with a fire fighting device associated with the located zone.

The method adopts all benefits and preferred embodiments of the fire fighting system mentioned herein above which is why reference is made to the description of the embodiments herein above. Preferred embodiments of the fire fighting system are at the same time preferred embodiments of the inventive method and vice versa.

In a preferred embodiment of the method, said method comprises the step of defining the location of stationary hot spots that are indicative of fire-unrelated heat sources by allocating specific threshold values to each pixel.

Further preferably, the sensing of electromagnetic radiation comprises sensing of at least one of: Ultraviolet light, visible light, or infrared light; and preferably comprises sensing heat radiation with thermopile array sensor, each pixel of the sensor comprising a thermopile element.

In a further preferred embodiment, the method further comprises the step of detecting the presence of the fire with at least one fire detector device selected from the list consisting of smoke detector, in particular or optical beam smoke detector or aspiration smoke detector; flame detector, in particular IR flame detector, UV flame detector or combined IR/UV flame detector; heat detector, gas detector, and multi-sensor-detector.

Preferably, the method further comprises a step of generating a signal indicative of the presence of the fire in the room, and activating the at least one fire fighting device only when the presence of the fire has been indicated by the at least one fire detector device, and the zone having the fire has been located based on the signals received from the fire locator device. Particularly preferred, the detection of the presence of the fire as being conducted with at least two fire detector devices selected from the above list, which may either be of the same type or different types.

In a further preferred embodiment, which is at the same time a separate aspect of the invention, the plurality of fire fighting devices are positioned and arranged in a room so as to respectively cover a zone of predetermined size, the method further comprising: Locating the zone containing the fire, and
a) if only one fire fighting device is positioned to cover the zone containing the fire, activating only that respective extinguishing device, or
b) if several fire fighting devices are positioned to cover the zone containing the fire, activating no more than two fire fighting devices covering the zone having the fire.

In a further aspect of the invention, the object mentioned herein above is achieved by suggesting the use of an array sensor in a stationary fire locator device in a system according to any one of the preferred embodiments described herein above.

The inventive use adopts all benefits, advantages and preferred embodiments of the systems and methods described herein above, which is why reference is made to the description of those embodiments herein above.

Preferred embodiments of the system and method are at the same time preferred embodiments of the use and vice versa.

Hereinafter, preferred embodiments of the invention will be described with reference to the accompanying drawings in greater detail. Herein,

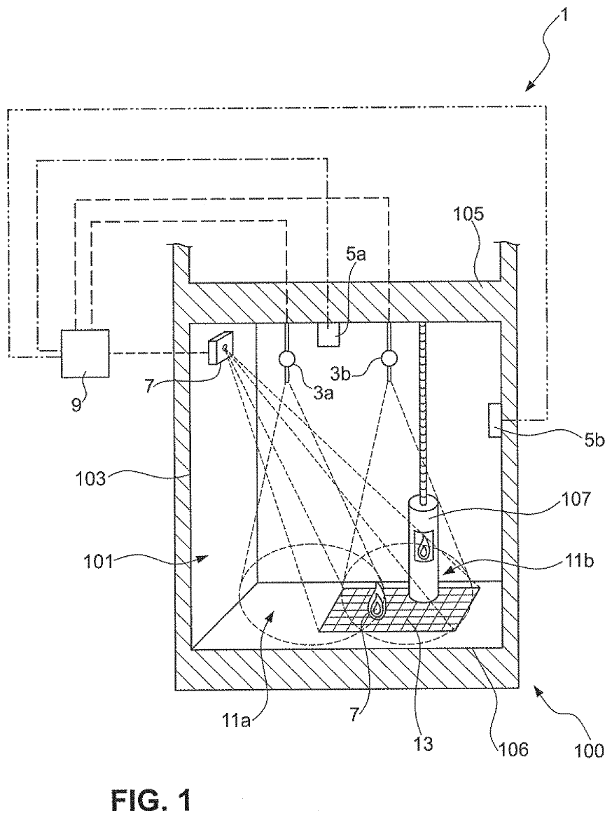

FIG. 1 shows a schematic view of a fire fighting system according to a preferred embodiment,

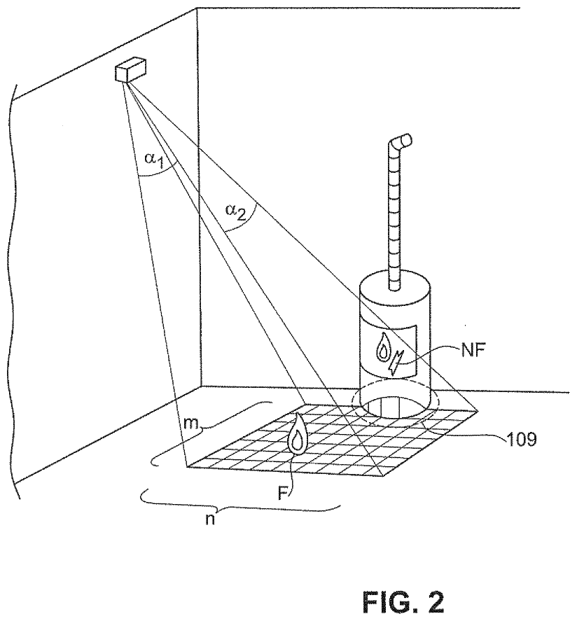

FIG. 2 shows a schematic detail view of the system according to FIG. 1,

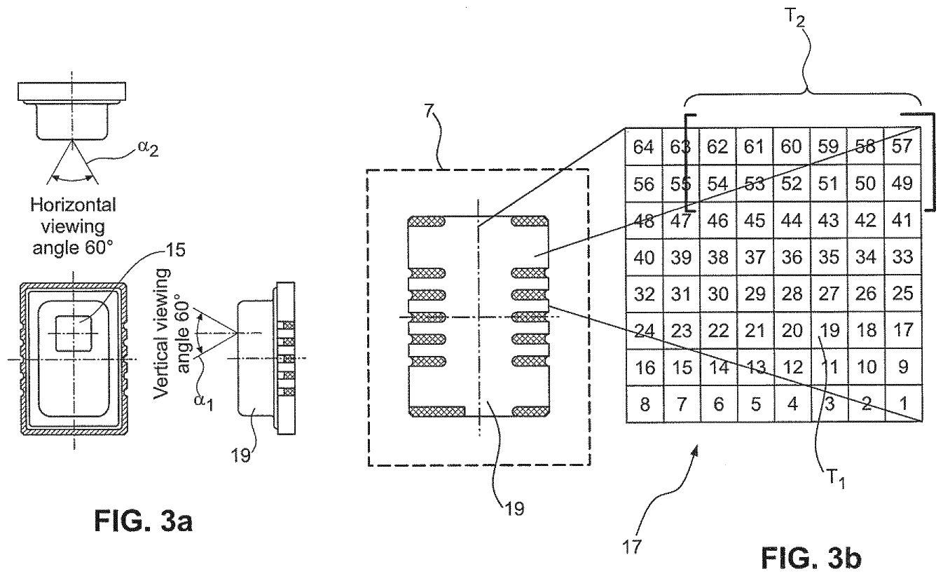

FIG. 3a, b show a schematic detail view of an array sensor used in the system of FIGS. 1 and 2.

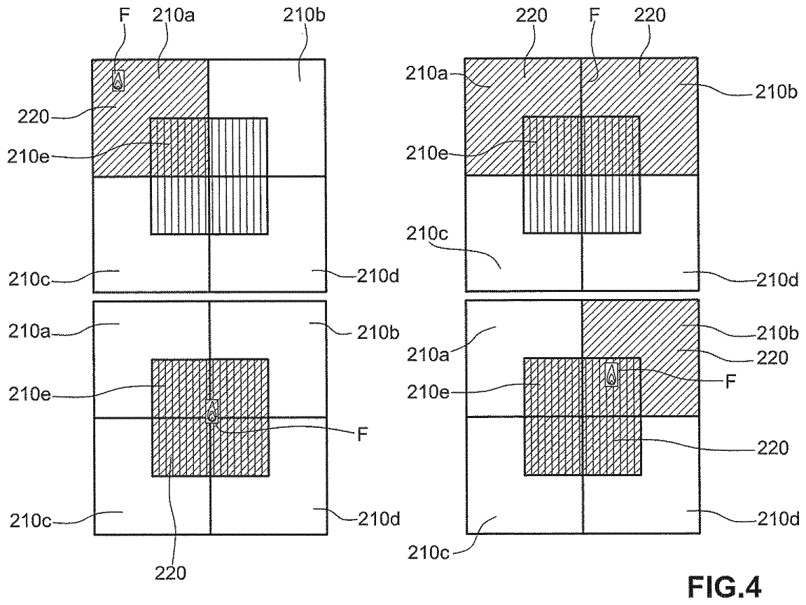

FIG. 4 a schematic view of a first example of zones in a room,

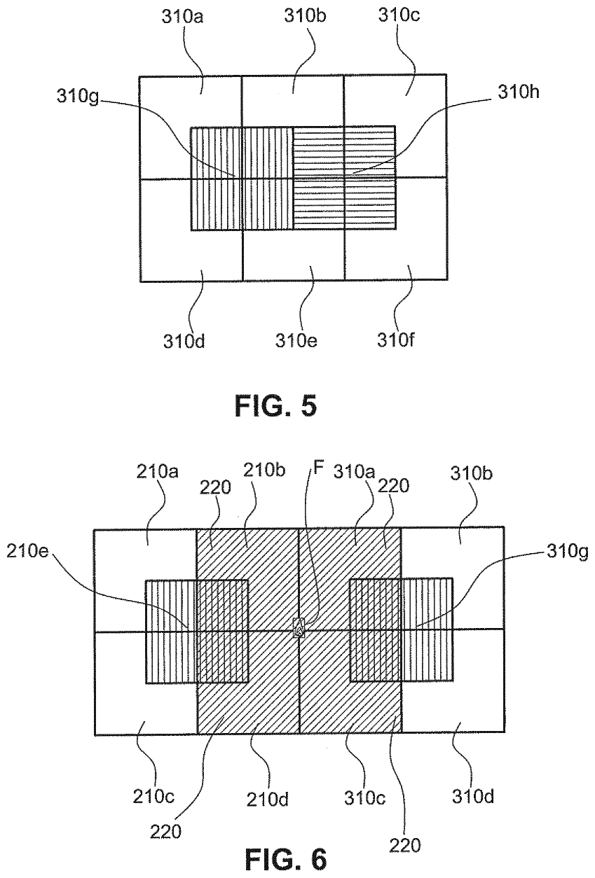

FIG. 5 a schematic view of a second example of zones in a room,

FIG. 6 a schematic view of a third example of zones in a room,

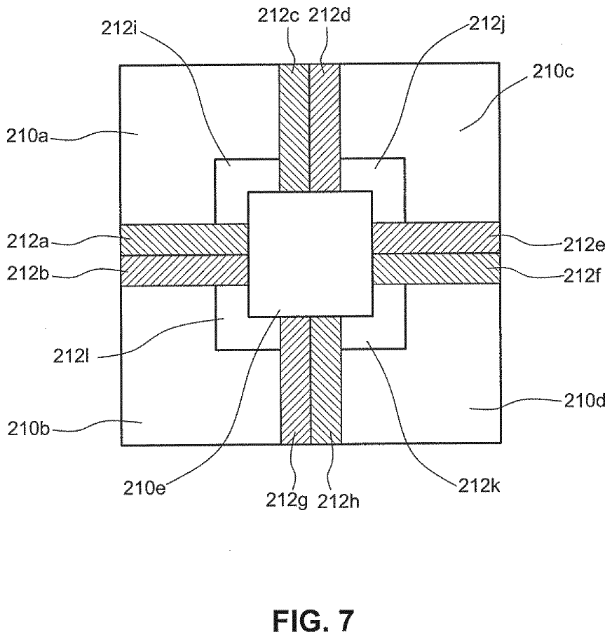

FIG. 7 a schematic view of a fourth example of zones in a room,

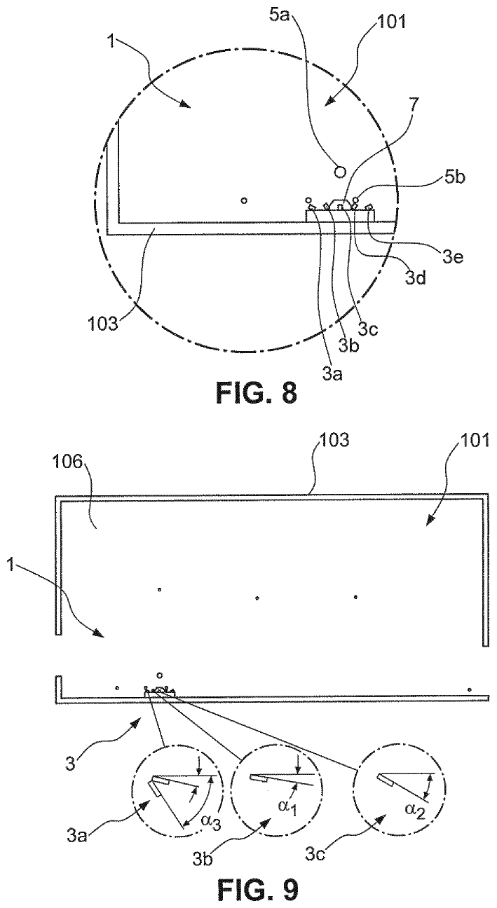

FIG. 8 a schematic detail view of a fire fighting system,

FIG. 9 a schematic view of the system of FIG. 8 in a room, and

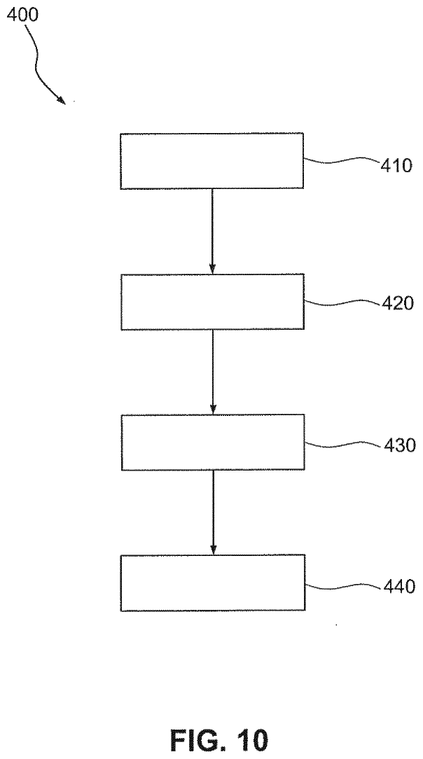

FIG. 10 schematically and exemplarily a flow chart of a method for fire fighting of a room.

FIG. 1 shows a fire fighting system 1. The fire fighting system 1 is installed in a room 101 of a building 100. The room comprises a number of walls 103, a ceiling 105 and a floor 106. Inside the room 101, a heat source 107 is installed.

It should be noted that, while an entire room 101 is illustrated in FIG. 1 and some of the consecutive figures, the system according to the invention can also be provided to protect only a part of the room. In this case, also a plurality of systems 1 according to the invention can be provided to protect the entire room. Thus, a room according to this invention is used as a defined space under protection by fire fighting system 1, which can also be a part of a physical room, i.e. a construction being enclosed by walls and ceiling.

The system 1 comprises a number of fire fighting devices 3a, b which are installed for example under the ceiling 105 of the room 101, but could alternatively also be wall-mounted. The fire fighting devices 3a, b may for example be open extinguishing nozzles of a deluge system.

The system 1 further comprises a plurality of fire detection devices 5a, b installed in the room 101, for example under the ceiling 105 and/or on one of the walls 103.

The system 1 further comprises a fire locator device 7 that is configured to locate a fire F in the room 101. The fire detector devices 5a, b are configured to detect the presence of a fire in the room 101. The fire fighting devices 3a, b are each positioned such that they distribute fire extinguishing fluid within a respective coverage zone 11a, b (hereinafter also “zone”) of the room 101. The zones 11a, b may overlap.

System 1 further comprises a controller 9 which is in signal communication with the fire fighting devices 3a, b with the fire detection devices 5a, b and with the fire locator device 7. The controller 9 is configured to activate the fire fighting devices 3a, b in reaction to a detection of the fire F as is detailed further herein below.

The fire locator device 7 comprises an array sensor 19 (FIGS. 3a, b) which has a defined field of view having a first view angle α1, e.g. a vertical angle, and a second view angle α2, e.g. a horizontal angle. (FIG. 2). Within its field of view, the array sensor 19 is adapted to monitor a predetermined area of the room 101. The array sensor 19 comprises a sensor array 15 having a plurality of n x m pixels arranged in a grid 17. Since the fire locator device 7 is stationary, i.e. fixedly installed in the room 101, once oriented, each of the pixels of the grid 17 is specifically assigned to a specific portion of the room 101. Depending on the distance of the fire locator device 7 from e.g. the floor 106 of the room 101 and depending on the specific view angles α1, α2, the grid 17 of pixels defines a projection 13 of the pixel grid 17 in the room 101, and in the embodiment shown in FIG. 1, encompassing a portion of the floor 106 of the room 101. A fire F which lies within this projection 13 will be detected by the grid 17 of the sensor array 15.

Preferably, the sensor array 15 is an infrared sensor array, in particular a thermopile array. The array sensor 19 is configured to permanently generate for each pixel a signal representative for a temperature within the portion of the projection 13 in the room 101. The fire F will cause representative temperature signals to be generated by the array sensor 19. The controller 9 is configured to receive the representative temperature signals from the array sensor 19. Also, the controller 9 is configured to allocate specific threshold values T₁, T₂ to each pixel of the sensor array 15. There may be two or more different threshold values used across the array. According to the invention, it is possible to designate a threshold value that will be reached only in case of a fire, or not be reached at all, the latter being especially useful to permanently “blind” the array sensor from certain stationary hot spots that are indicative of non-fire related heat sources.

However, each threshold value may also be indicative of a temperature limit, the breach of which happens only in case of a fire in that specific portion of the room. As soon as the temperature in the pixels of the sensor array 15 exceeds the predetermined threshold levels T1, T₂, the controller not only has identified the presence of a fire F in the room 101, but additionally has located the portion within the projection 13 where the fire F recites by identifying the respective hot spot among the grid 17 of pixels. This allows for very efficient allocation of the fire fighting device 3a or 3b that is ideally positioned to distribute extinguishing fluid in the zone where the fire F has been located. Depending on whether the fire has been located in a zone that is overlapped by the zones 11a, b of a plurality of fire fighting devices 3a, b, the controller 9 may also activate more than one fire fighting device 3a, b, but ideally no more than two fire fighting devices 3a, b.

In many rooms, in particular residential rooms, it is to be expected that stationary heat sources such as heat source 107 are present in a portion of the room monitored by the fire locator device 7. In order to prevent false fire alarms, and in order to prevent inaccurate location of actual fires due to the influence of stationary heat sources, the controller 9 is configured to assign specific threshold values T₂ to all pixels which are within range of the stationary hot spot 109 formed by the stationary heat source 107. As is depicted in FIG. 2 and FIG. 3b, the controller 9 could for example be programmed to assign a higher threshold value T₂ to pixels 49 through 54 and 57 through 62, while assigning a lower threshold value T₁ to the remaining pixels of the grid 17. By doing so, increased radiation emanating from heat source 107 would not be flagged as hotspots indicative of a fire F, unless the predetermined higher threshold value T₂ is exceeded.

This allows the controller 9 to distinguish between a fire F and a fire-unrelated heat source NF. Basically, any number of stationary heat sources may be accounted for in this way.

While the embodiments of FIGS. 1 through 3b show a simple set-up of a room 101 having only one fire locator device, the invention also covers embodiments wherein the room 101, either due to its size or due to its complexity of its layout, requires the use of more than one fire locator device. Preferably, the entire floor 106 of the room is covered by projections 13 of the grids 17 of pixels of specifically mounted and oriented fire locator devices 7. Depending on economic factors and ease of installation, the number of fire locator devices for the size of the grid 17 of pixels for each fire locator device 7 may be modified according to need. At any rate, the invention allows for the use of array sensors 19 having sensor arrays 15 with comparatively low resolution (in particular when compared to prior art systems using high-res infrared camera systems).

FIGS. 4 to 7 schematically and exemplarily illustrate different configurations or distributions of zones 210a-210e or 310a-310h in different rooms, respectively.

FIG. 4 illustrates a layout of four zones 210a-210d, which are equal in size and apportion the surface area of the room among them. In other words, the four zones 210a-210d cover the entire surface area, i.e. the floor and—if necessary—at least part of the wall surface area of the room. A further, fifth zone 210e is located in the center of the room and overlays all of the other four zones in the center of the room. Fifth zone 210e is thus redundant and provided to limit the spacial extension and also the amount of the fire extinguishing fluid dispersion.

In FIG. 4, four examples of a fire F at different locations within the illustrated room, i.e. within different zones 210a-210e, are illustrated. Each of the examples of the fire F leads to the determination of an fire fighting area 220 by the controller 9, which is as follows. In the first example, since the fire F is located within zone 210a, the fire fighting area is determined to be comprised of zone 210a. In the second example, the fire F is located at the edge between zone 210a and zone 210b, such that both zone 210a and zone 210b are determined as the fire fighting area 220. The third example shows the fire F in the center of the room. In this example, only zone 210e is determined as fire fighting area 220. In the last example, the fire F is located close to the center within zone 210b. Thus, both the central zone 210e and zone 210b are determined as fire fighting area 220. In these examples, for the reasons discussed above, it is preferred that not more than two zones 210a-210e be determined as fire fighting area 220.

In this example, both the room and each of the respective zones 210a-210e are of quadratic shape for the ease of illustration, while of course also different examples of shapes are contemplated. The quadratic shape is particularly beneficial in combination with specific controllable nozzles as fire fighting devices, e.g. fire fighting device 3a-3e, such as a Viking Model A full cone nozzle or a similarly operating, publically available nozzle.

FIG. 5 substantially corresponds to the example of FIG. 4, wherein the room—or likewise a part of the room—is rectangular and its surface is distributed among six zones 310a-310f, which are also in this example quadratic and of equal size. Two central zones 310g and 310h are respectively provided to overlap four adjacent of the zones 310a-310f, respectively. The determination of a fire fighting area 220 is performed analogous to the example of FIG. 4. In other word, not more than two zones 310a-310h are determined to be part of the fire fighting area (not shown in FIG. 5) at the time.

FIG. 6 schematically illustrates a further example, wherein the room is split into two substantially independent regions of five zones 210a-210e, 310a-310d and 310g, respectively. For examples, each of the two groups of five zones can be coordinated and controlled by a particular, individual controller 9 and/or fire locator device 7. In other examples, the two groups can also be controlled commonly by a single controller 9 and/or fire locator device 7.

In the example of FIG. 6, the two fully overlapping regions 210e, 310g are not adjacent to each other, different from the example of FIG. 5, in which two completely overlapping zones 310g, 310h are adjacent to each other. In the example of FIG. 6 a fire F is illustrated in the center of the room. In this example, the fire fighting area 220 is extended to include two zones 210b, 210d, and 310a, 310c of each of the first and second group of zones 210, 310, respectively.

Accordingly, in this example also the situation, in which more than two zones are comprised in the fire fighting area 220 is illustrated. The example of FIG. 6 is particularly useful in case two substantially independent systems for fire fighting are arranged in the same room. In this case, two zones per independent system are comprised in the fire fighting area 220, respectively. Then, again, not more than two zones will be activated concurrently, i.e. designated as the fire fighting area 220.

It is of course contemplated that also in the example of FIG. 6 a further fully overlapping zone can be defined in between the zones 210e and 310g. In this particular case, it would be beneficial to protect the entire room as illustrated in FIG. 6 with a single system for fire fighting according to the invention.

FIG. 7 schematically and exemplarily illustrates the effect of overlapping zones in the example of five zones 210a-210e. In this example, overlapping regions 212a-212k are formed in the overlapping area between two adjacent zones 210a-210e, respectively.

Overlapping regions 212a and 212b correspond to the region in which zone 210a overlaps zone 210b and vice versa. Accordingly, the fire fighting area 220 in case a fire F is detected in either region 212a or region 212b will be comprised of both zone 210a and 210b. Likewise, in overlapping regions 212c and 212d zones 210a and 210c will form the fire fighting area 220. A fire F in overlapping region 212e or 212f will yield a fire fighting area 220 with zones 210c and 210d, while a fire F in overlapping region 212g or 212h will result in fire fighting area 220 being formed of zones 210b and 210d.

Finally, in case a fire is present in the outer region of zone 210e, i.e. the region near the edge of zone 210e, which are indicated with 212i, 212j, 212k or 212l, the fire fighting area 220 is formed of zone 210e and one of zones 210a-210d, respectively. Thus, also in this example with overlapping regions, it can be ensured that not more than two zones will be comprised in the fire fighting area 220 at the same time.

FIG. 8 and FIG. 9 schematically and exemplarily illustrate a further example of the system 1 according to, for example, FIG. 1. In FIG. 8, it can be particularly seen that a fire locator device 7 is mounted at or on the side wall 103 or the room 101.

The fire locator device 7 comprises, not shown in detail, the array sensor 19. Further, in this example, fire locator device 7 is mounted together with five controllable nozzles, i.e. fire fighting devices 3a, 3b, 3c, 3d, 3e. Preferentially, at least the fire fighting devices 3a, 3b, 3c, 3d, 3e and the fire locator device 7 are mounted on or in a single housing, while in other examples also at least two housings can be provided for the respective components. Each of the five fire fighting devices 3a, 3b, 3c, 3d and 3e can be corresponded to, for instance, one of five zones, respectively.

Finally, two additional fire detection devices 5a, 5b are provided. The location of the fire detection devices 5a, 5b is of course only an example and also different locations within the room 101 are contemplated.

In particular, fire detection device 5a, for instance a smoke detector, is illustrated near the center of room 101 and used as a double interlock safety feature, i.e. the fire fighting devices 3a-3e, 3c, 3d, 3e are only operated by controller 9 in case also at least one of the additional fire detection devices 5a and 5b detects a fire in the room 101. The second additional fire detection device 5b can also be a smoke detector or any other detector, which is preferentially arranged to detect a fire within the room 101. In contrast to fire detection device 5a, fire detection device 5b is mounted nearby fire locator device 7, thereby facilitating mounting of the entire system 1.

FIG. 9 illustrates the example of FIG. 8 in a different scale. In particular, it can be seen in FIG. 9 that different fire fighting devices 3a, 3b and even 3c are provided with a different orientation α1, α2, α3 with respect to the direction of side wall 103. The number of three fire fighting devices 3a, 3b, 3c is of course not limited and can be more or less than three. Further, also in the other examples illustrated above more or less fire fighting devices can be provided.

FIG. 10 schematically and exemplarily illustrates a flowchart of a method 400 for fire fighting of a room, such as room 101 discussed above, using system for fire fighting, such as system 1 discussed above.

The system 1 particular comprises one or more fire locator devices 7 mounted on at least one of a wall 103 and a ceiling 105 of the room 101. Each of the fire locator devices 7 comprises an array sensor, such as array sensor 19, having a grid 17 of sensor elements.

The system further comprises a controller and a plurality of controllable nozzles as fire fighting devices 3a-3e, which are mounted on at least one of the wall 103 and ceiling 105 of the room 101. Each of the fire fighting devices 3a-3e is arranged to selectively release or stop a supply of fire extinguishing fluid to one of the plurality of zones 210a-210e, 310a-310h upon activation by the controller 9.

The method 400 comprises operating the controller 9 to carry out the following steps:

A step 410 of associating each of the sensor elements of the array sensor 19 to at least one zone 210a-210e, 310a-310h of the room 101, the at least one zone 210a-210e, 310a-310h being one of a plurality of zones 210a-210e, 310a-310h, each of the plurality of zones 210a-210e, 310a-310h comprising at least one of floor surface and wall surface of the room 101.

A step 420 of determining the presence of a fire F in at least one of the zones 210a-210e, 310a-310h responsive to a signal from the array sensor 19. Accordingly, the location of the fire F is determined in this step.

A step 430 of identifying a fire fighting area 220 in the at least one of the zones 210a-210e, 310a-310h in which the fire F is present. Based on the location of the fire F, which was determined in step 420, the fire fighting area 220 is thus identified.

A step 440 of controlling the plurality of fire fighting devices 3a-3e to provide fire extinguishing fluid to the fire fighting area 220 such that any square meter (m²) of floor surface in the fire fighting area 220 is provided with at least 0.4 (l/m²)/min of fire extinguishing fluid corresponding to at least 0.1 gpm/sqf. Preferably, before controlling the fire fighting devices 3a-3e to provide the fire extinguishing fluid, a fire detector, such as a smoke detector, is required to detect the presence of the fire-condition. Expressed differently, the fire detector detecting the fire is the requirement for the activation of any of the fire fighting devices 3a-3e.

The present disclosure thus relates to a system 1 and a corresponding method 400 for fire fighting of a room 101 comprising one or more fire locator devices 7 comprising an array sensor 19 having a grid 17 of sensor elements each; a controller 9 that associates each of the sensor elements of the array sensor 19 to at least one zone 210a-210e, 310a-310h; a plurality of controllable fire fighting devices 3a-3e being arranged to selectively release a supply of fire extinguishing fluid to one of the plurality of zones 210a-210e, 310a-310h upon activation by the controller 9.

### LIST OF REFERENCE SIGNS

1 system

3a,b,c,d,e fire fighting device

5a,b fire detection device

7 fire locator device

9 controller

11a,b zone

13 projection of pixel grid

15 array

17 pixel grid

19 array sensor

100 building

101 room

103 side wall

105 ceiling

106 floor

107 heat source

109 stationary hot spot

210a-e zone

212a-l overlapping region

220 fire fighting area

310a-h zone

400 method for fire fighting

410 associating step

420 determination step

430 identifying step

440 control step

m, n grid parameters

F fire

NF fire-unrelated heat source

T₁, T₂ threshold

α₁, α₂, α₃ angle, field of view

1. A fire fighting system for extinguishing a fire in a room of a building, comprising:
at least one stationary fire locator device configured to locate a fire,
a plurality of stationary fire fighting devices, each associated with and configured to distribute fire extinguishing fluid within a respective zone of the room, and
a controller that is in signal communication with the at least one locator device and with the extinguishing devices, and is configured to activate at least one of the fire fighting devices in reaction to identifying the fire;
wherein the at least one locator device comprises an array sensor, said array sensor having a plurality of pixels that are sensitive to electromagnetic radiation, and arranged in a grid of pixels, wherein each pixel is associated with a specific portion of the room, and
wherein the controller is configured to:
locate the zone of the room having the fire by identifying hot spots formed by those pixels which sense electromagnetic radiation exceeding a predetermined threshold level, and
activate the at least one fire fighting device associated with the located zone.

2. The fire fighting system of claim 1, wherein the controller is configured to allocate specific threshold values to each pixel.

3. The fire fighting system of claim 1, wherein the pixels are sensitive to at least one of: ultraviolet light, visible light, or infrared light.

4. The fire fighting system of claim 1, wherein the array sensor is a thermopile array sensor, each pixel comprising a thermopile element.

5. The fire fighting system of claim 1, further comprising at least one fire detector device in addition to the fire locator device, the fire detector device being selected from the list consisting of: smoke detector, optical beam smoke detector, aspiration smoke detector; flame detector, IR flame detector, UV flame detector, combined IR/UV flame detector; heat detector; gas detector; or multi-sensor-detector.

6. The fire fighting system of claim 5, wherein the at least one fire detector device is configured to generate a signal indicative of the presence of the fire in the room, and the controller is configured to activate the at least one fire fighting device only when the at least one fire detector device has indicated the presence of the fire, and the controller has located the zone having the fire based on the signals received from the fire locator device.

7. The fire fighting system of claim 4, wherein the at least one fire locator device comprises a plurality of fire detector devices.

8. The fire fighting device of claim 1, wherein the fire locator device comprises a microprocessor that is configured to determine the temperature in each portion of the room associated with a respective one of the pixels and generate a signal representative of said temperatures.

9. The fire fighting system of claim 1, each of the fire fighting devices having a controlled trigger that is configured to activate a flow of extinguishing fluid from the fire fighting device upon receipt of an activation signal; and the controller being configured to generate said activation signal as a function of identifying and locating the fire.

10. The fire fighting system of claim 1, wherein the plurality of fluid extinguishing devices are positioned and arranged in the room so as to respectively cover a zone of predetermined size, the controller being configured to locate the zone containing the fire, and
a) if only one fire fighting device is positioned to cover the zone having the fire, to activate only that respective extinguishing device, or
b) if several fire fighting devices are positioned to cover the zone having the fire, to activate no more than two fire fighting devices covering the zone having the fire.

11. The fire fighting system of claim 1, the room having a wall, a ceiling and a floor, wherein the at least one fire locator device is mounted to the wall or ceiling of the room and has a defined field of view directed towards the floor of the room, each of the pixels being associated with a segment of said field of view, such that each pixel covers a specific portion of the floor of the room.

12. The fire fighting system of claim 1, wherein the fire fighting system is a deluge system, and the fire fighting devices respectively comprise an open extinguishing nozzle including one of: full cone spray nozzles, open side wall sprinkler type nozzles, or open nozzles with a flat spray pattern.

13. The fire fighting system of claim 1, wherein the fire fighting system is a water based extinguishing system, and the fire fighting device respectively comprises a controllable sprinkler, activated by the controlled trigger.

14. The fire fighting system of claim 13, wherein the controllable sprinkler is designed as
an electrically activatable sprinkler, or
a nozzle cooperating with or comprising a sealing device which is configured to open to discharge a fire extinguishing fluid in response to receiving an electrical signal.

15. A method of extinguishing a fire in a room of a building, comprising the steps of:
locating a zone of the room having a fire with at least one stationary fire locator device by sensing electromagnetic radiation with a grid of pixels of an array sensor, wherein each pixel is associated with a predetermined specific portion of the room,
identifying hot spots formed by those pixels which sense electromagnetic radiation exceeding a predetermined threshold level; and
distributing an extinguishing fluid from at least one of a plurality of stationary fire fighting devices to the located zone.

16. The method of claim 15, comprising: defining the location of stationary hot spots that are indicative of fire-unrelated heat sources by allocating specific threshold values to each pixel.

17. The method of claim 15, wherein the sensing of electromagnetic radiation comprises sensing of at least one of: ultraviolet light, visible light, or infrared light; and comprises sensing heat radiation with a thermopile array sensor, each pixel of the sensor comprising a thermopile element.

18. The method of claim 15, further comprising the step of detecting the presence of the fire with at least one fire detector device selected from the list consisting of: smoke detector, optical beam smoke detector, aspiration smoke detector; flame detector, IR flame detector, UV flame detector, combined IR/UV flame detector; heat detector; gas detector; or multi-sensor-detector.

19. The method of claim 18, comprising a step of
generating a signal indicative of the presence of the fire in the room, and
activating the at least one fire fighting device only when the presence of the fire has been indicated by the at least one fire detector device, and the zone having the fire has been located based on the signals received from the fire locator device.

20. The method of claim 15, wherein the plurality of fluid extinguishing devices are positioned and arranged in the room so as to respectively cover a zone of predetermined size, the method further comprising:
locating the zone containing the fire, and
a) if only one fire fighting device is positioned to cover the zone containing the fire, activating only that respective extinguishing device, or
b) if several fire fighting devices are positioned to cover the zone containing the fire, activating no more than two fire fighting devices covering the zone having the fire.

21. (canceled)
